(19) United States
(12) Patent Application Publication
(10) Pub. No.: US 2017/0161837 A1
(43) Pub. Date: Jun. 8, 2017

(54) USER INTERFACE FOR LATENT RISK ASSESSMENT

(71) Applicant: Praedicat, Inc., Los Angeles, CA (US)

(72) Inventors: David LOUGHRAN, Los Angeles, CA (US); Robert Thomas REVILLE, Los Angeles, CA (US); Grant CAVANAUGH, Oakland, CA (US); Naresh CHEBOLU, Los Angeles, CA (US)

(73) Assignees: Praedicat, Inc., Los Angeles, CA (US); Praedicat, Inc., Los Angeles, CA (US)

(21) Appl. No.: 14/960,143

(22) Filed: Dec. 4, 2015

(51) Int. Cl. G06Q 40/08

(52) U.S. Cl. CPC G06Q 40/08

(57) ABSTRACT

Embodiments of the disclosure are directed toward a latent risk assessment user interface, including generating one or more curves that indicate expected future losses due to one or more agents. Embodiments of the disclosure can visualize such losses by mapping estimated litigation losses over time in a loss-time curve and/or generating an exceedance probability curve that indicates total losses at various probabilities. Further, the latent risk assessment user interface can allow a user to select multiple agents and/or multiple companies for aggregation/comparison in a single user interface. Such a user interface can be useful for an insurance company or reinsurer with a portfolio of many companies across diverse industries that utilize the same agents. For example, the latent risk assessment user interface can display estimated future litigation losses over time due to use of BPA and carbon nanotubes for a portfolio of multiple companies, displayed in a single aggregated visualization.

### FIELD OF THE DISCLOSURE

This relates generally to computer user interfaces for latent risk assessment.

### SUMMARY

Embodiments of the disclosure are directed toward a latent risk assessment user interface, including generating one or more curves that indicate expected future losses due to one or more agents. An agent may include any hypothesized cause of an outcome, including a chemical, a material, a process, a business practice, and/or a behavior, among numerous other possibilities. For example, there is a possibility that the agent bisphenol A (BPA) may be linked to the outcome breast cancer. As a result, there is a possibility that any company that uses or produces BPA may incur future losses due to litigation claims from employees or customers. Embodiments of the disclosure can visualize such possibilities by mapping estimated litigation losses over time in a loss-time curve and/or generating an exceedance probability curve that indicates total losses at various probabilities.

Further, the latent risk assessment user interface can allow a user to select multiple agents and/or multiple companies for aggregation/comparison in a single user interface. Such a user interface can be useful for an insurance company or reinsurer with a portfolio of many companies across diverse industries that utilize the same agents. For example, the latent risk assessment user interface can display estimated future litigation losses over time due to use of BPA and carbon nanotubes for a portfolio of multiple companies, displayed in a single aggregated visualization.

### BRIEF DESCRIPTION OF THE DRAWINGS

FIGS. 1A-1B illustrate an exemplary latent risk assessment user interface according to embodiments of the disclosure.

FIG. 2 illustrates an exemplary microsimulation for generating a plurality of simulated claims according to embodiments of the disclosure.

FIG. 3 illustrates an exemplary microsimulation decision tree according to embodiments of the disclosure.

FIG. 4 illustrates an exemplary settlement model according to embodiments of the disclosure.

FIG. 5 illustrates an exemplary allocation of losses from simulated claims among a plurality of companies according to embodiments of the disclosure.

FIGS. 6A-6C illustrate an exemplary method of a latent risk assessment user interface according to embodiments of the disclosure.

FIG. 7 illustrates an exemplary system for a latent risk assessment user interface according to embodiments of the disclosure.

### DETAILED DESCRIPTION

In the following description of embodiments, reference is made to the accompanying drawings which form a part hereof, and in which it is shown by way of illustration specific embodiments which can be practiced. It is to be understood that other embodiments can be used and structural changes can be made without departing from the scope of the disclosed embodiments.

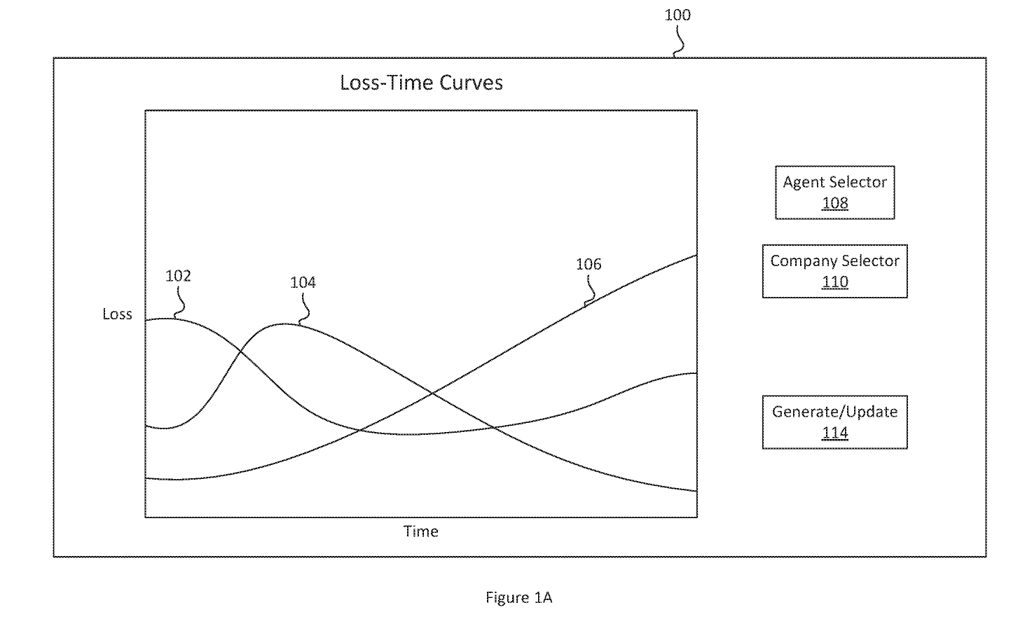

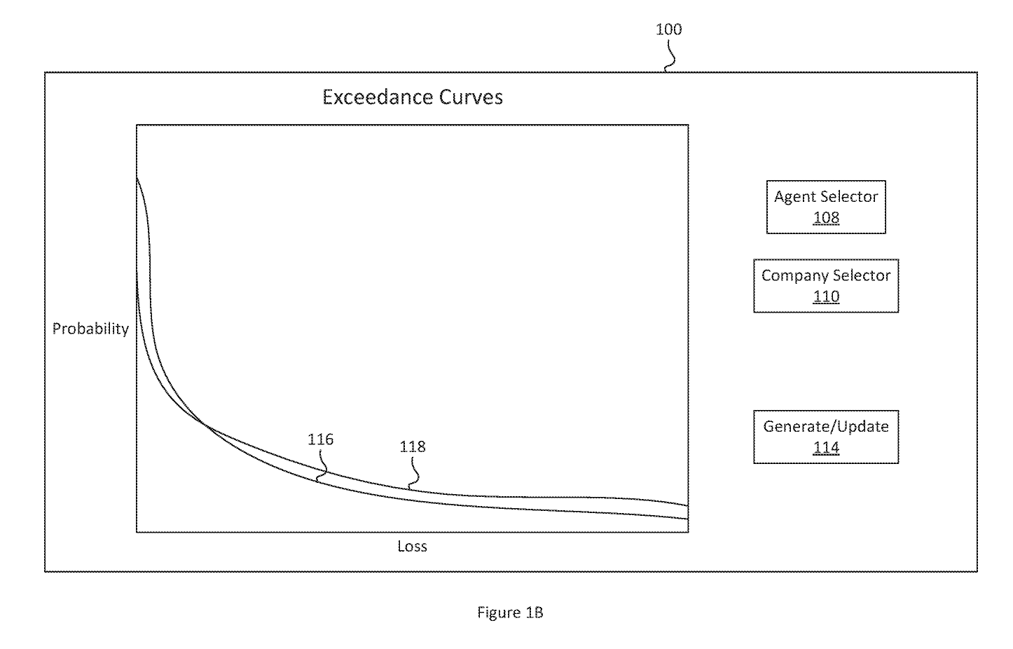

Embodiments of the disclosure are directed toward a latent risk assessment user interface, including generating one or more curves that indicate expected future losses due to one or more agents. An agent may include any hypothesized cause of an outcome, including a chemical, a material, a process, a business practice, and/or a behavior, among numerous other possibilities. For example, there is a possibility that the agent bisphenol A (BPA) may be linked to the outcome breast cancer. As a result, there is a possibility that any company that uses or produces BPA may incur future losses due to litigation claims from employees or customers. Embodiments of the disclosure can visualize such possibilities by mapping estimated litigation losses over time in a loss-time curve (e.g., FIG. 1A) and/or generating an exceedance probability curve (e.g., FIG. 1B) that indicates total losses at various probabilities.

Further, the latent risk assessment user interface can allow a user to select multiple agents and/or multiple companies for aggregation/comparison in a single user interface. Such a user interface can be useful for an insurance company or reinsurer with a portfolio of many companies across diverse industries that utilize the same agents. For example, the latent risk assessment user interface can display estimated future litigation losses over time due to use of BPA and carbon nanotubes for a portfolio of multiple companies, displayed in a single aggregated visualization.

In some embodiments, the microsimulations used in generating the visualizations can rely on probabilities and event sets generated from empirical data and studies, such as those found in biomedical literatures. For example, a model can be used to estimate the scientific acceptance of a hypothesis that a particular agent causes a particular injury in a particular exposure setting. Further, the state of scientific acceptance can be projected into the future, and a distribution of possible future states of science can be generated. Liability risk can then be estimated based on the distribution of possible future states of science. These probabilities and distributions can be used as inputs to the microsimulations to inform (1) whether a representative individual would make a claim based on an injury, and/or (2) the likelihood of success of the claim once it is made. Methods of generating such probabilities and event sets are described in U.S. patent application Ser. Nos. 14/135,436 and 14/282,998, which are incorporated herein by reference in their entirety. Further, the data described herein can be used to generate further visualizations, such as those described in U.S. patent application Ser. No. 13/924,316, which is incorporated herein by reference in its entirety.

Although embodiments of the disclosure are described as accepting user input through a user interface, including selecting one or more agents, companies, industries, and/or time intervals through a user interface, embodiments are not so limited. In some embodiments, one or more agents, companies, industries, and/or time intervals may be selected based on input received through one or more Application Programming Interfaces (APIs) or via batch input from databases or configuration files, among other possibilities.

FIGS. 1A and 1B illustrate an exemplary latent risk assessment user interface 100 according to embodiments of the disclosure. In some embodiments, the latent risk assessment user interface 100 includes a plurality of loss-time curves (e.g., a first loss-time curve 102, a second loss-time curve 104, and a third loss-time curve 106), as illustrated in FIG. 1A. A loss-time curve indicates expected losses over time, as plotted on a loss axis and a time axis. Each curve can be associated with a probability level. For example, the first loss-time curve 102 indicates an expected time path of losses for the scenario that generates aggregate losses at the 99th percentile of the aggregate loss distribution, the second loss-time curve 104 indicates an expected time path of losses for the scenario that generates aggregate losses at the 95th percentile of the aggregate loss distribution, and the third loss-time curve 106 indicates an expected time path of losses for the scenario that generates aggregate losses at the 90th percentile of the aggregate loss distribution.

In some embodiments, a loss-time curve indicates expected losses of a particular set of one or more companies due to a particular set of one or more agents. An agent can be a hypothesized cause of an outcome or injury. For example, an agent can be a chemical, a material, a process, a business practice, and/or a behavior, among numerous other possibilities.

The particular set of agents on which to generate the loss-time curves can be selected based on user input. For example, a user optionally selects one or more agents from a list of agents using the agent selector 108. Similarly, the particular set of companies on which to generate the loss-time curves can be selected based on user input. For example, a user optionally selects one or more companies from a list of companies using the company selector 110.

Although FIGS. 1A-1B illustrate a company selector 110, in some embodiments, an industry selector may be used alternatively or in addition to the company selector, and the corresponding analysis and visualizations may be generated on a per-industry basis, as opposed to a per-company basis.

In some embodiments, the one or more loss-time curves are generated and displayed in response to user input on a user interface object 114 for generating or updating the curves 102, 104, and 106. For example, a user may select a first agent and a second agent using the agent selector 108 and a first company using the company selector 110. Then, in response to user input on the user interface object 114, a plurality of loss-time curves can be generated indicating expected losses of the first company due to the first and second agents. Then, the user may de-select the first agent, select a third agent, and select a second company. In response to further user input on the user interface object 114, the plurality of loss-time curves can be updated to indicate expected losses of the first and second companies due to the second and third agents. In some embodiments, the curves may be automatically updated/generated and displayed in response to selections using the agent selector 108 and/or the company selector 110, without the need to interact with an additional user interface object such as user interface object 114.

In some embodiments, the latent risk assessment user interface 100 includes one or more exceedance curves (e.g., a first exceedance curve 116, and a second exceedance curve 118), as illustrated in FIG. 1B. An exceedance curve (or a loss-probability curve) indicates probability of loss for a particular company due to a particular set of agents, as plotted on a loss axis and a probability axis. An exceedance curve can be generated by summing over time all of the losses at a particular probability level, and then plotting the losses over the various probability levels. By plotting multiple curves, each curve corresponding to a particular company, the probabilities and magnitudes of loss for each company can be compared directly. For example, the first exceedance curve 116 is associated with a first company, and the second exceedance curve 118 is associated with a second company.

As discussed above with reference to FIG. 1A, the particular set of agents on which to generate the exceedance curves can be selected using the agent selector 108. Further, the particular set of companies on which to generate the exceedance curves can be selected using the company selector 110.

In some embodiments, the one or more exceedance curves are generated and displayed in response to user input on a user interface object 114 for generating or updating the curves 116 and 118, and/or additional curves. For example, a user may select a first agent and a second agent using the agent selector 108 and a first company and a second company using the company selector 110. Then, in response to user input on the user interface object 114, the first exceedance curve 116 and the second exceedance curve 118 can be generated indicating probability of loss due to the first and second agents, with the first exceedance curve 116 indicating probability of loss for the first company, and the second exceedance curve 118 indicating probability of loss for the second company. Then, the user may de-select the first agent, select a third agent, and select a third company. In response to further user input on the user interface object 114, the plurality of exceedance curves can both be updated to indicate probability of loss due to the second and third agents. Further, a third exceedance curve can be generated indicating the probability of loss for the third company. In some embodiments, the curves may be automatically updated/generated and displayed in response to selections using the agent selector 108 and/or the company selector 110, without the need to interact with an additional user interface object such as user interface object 114.

Further, in some embodiments, multiple companies can be assigned to each exceedance curve, such that each curve represents a portfolio of companies, and probabilities of losses for portfolios of companies can be directly compared. In some embodiments, multiple industries can be assigned to each exceedance curve, such that each curve represents a portfolio of industries, and probabilities of losses for portfolios of industries can be directly compared. For example, a curve might represent probability of loss for a portfolio with 10% construction, 15% chemical manufacturing, 5% personal care product manufacturing, and 70% oil and gas exploration.

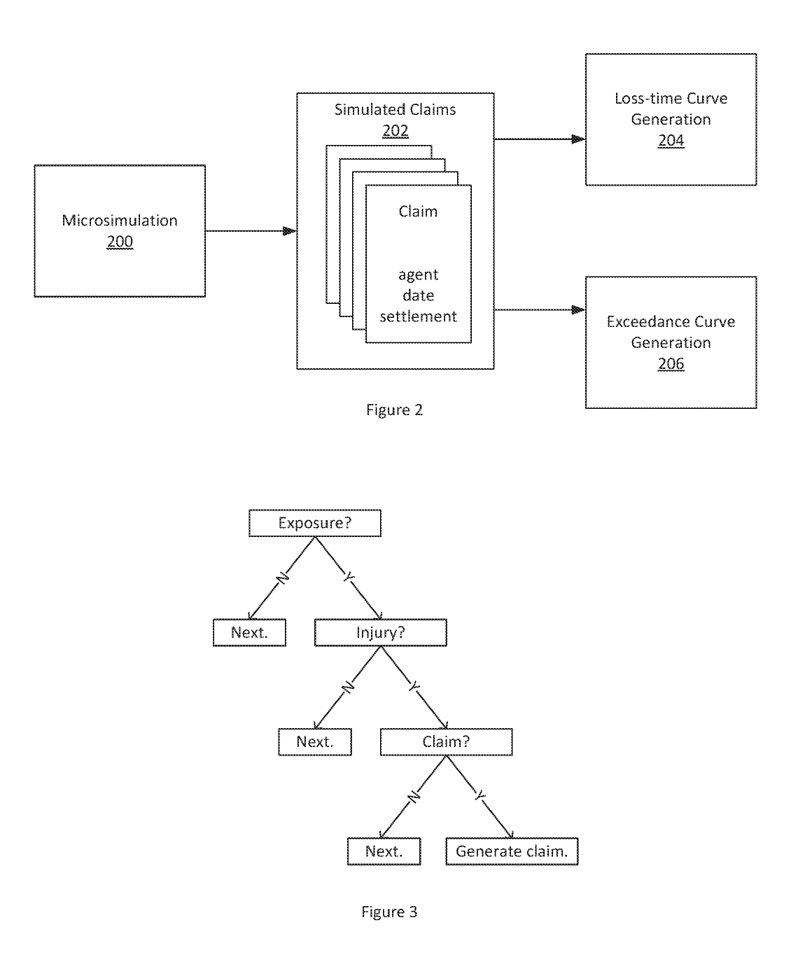

In some embodiments, the curves illustrated in FIGS. 1A-1B are generated based on a plurality of simulated claims generated in a microsimulation, as illustrated in FIG. 2 according to embodiments of the disclosure. A microsimulation 200 generates a plurality of simulated claims 202, each respective claim being associated with a particular agent (e.g., an agent that caused an injury that gave rise to the respective claim), a date (e.g., a year in which the respective claim would be paid (settlement date), or a policy year to which the respective claim is assigned (policy date), among other possibilities), and a settlement amount (e.g., an estimated settlement amount to cover an injury that gave rise to the respective claim). Then, the loss-time curve generation 204 and the exceedance curve generation 206 are based on the plurality of simulated claims 202.

In some embodiments, the microsimulation includes generating populations of representative individuals, then simulating exposure to agents, injury after exposure, and filing claims in response to injury, and then estimating a settlement for each simulated claim. A representative individual can, for example, represent a birth cohort or other group of individuals. FIG. 3 illustrates a portion of an exemplary microsimulation decision tree according to embodiments of the disclosure. The decision tree includes, for a representative individual in a given exposure setting associated with a given agent, a probability of exposure and a probability of injury after that exposure. Further, the decision tree includes a probability of filing a claim due to the injury. In some embodiments, a microsimulation would include a plurality of such decisions trees, including probabilities that correspond to different agents and exposure settings in a litigation event set.

In some embodiments, the probabilities may be computed based on data. For example, the probability of injury after exposure to a given agent in a given exposure setting may be computed based on an observed incidence rate of injury in that exposure setting. In another example, the probability that a representative individual makes a claim can be based on an estimated probability of success for that claim. For example, a probability of success may include a liability risk score calculated based on a general causation score (e.g., a likelihood that the agent causes the harm, calculated based on scientific literature) and/or a specific causation score (e.g., a likelihood that a particular defendant in a particular setting was responsible for a harm). In some embodiments, the probability of success is based on a probability distribution of scores estimated based on the particular date in the microsimulation. This allows the probability of making a claim to change over time in the microsimulation as the estimated state of science changes.

The microsimulation can track the simulated populations of representative individuals as they experience these events (e.g., exposure, injury, filing a claim, etc.) over time. For example, a microsimulation can include generating a first representative individual in a microsimulation population. For every time step in the microsimulation, the first representative individual experiences the possibility of exposure to a first agent. If, based on the probability of exposure to the first agent, the first representative individual is exposed during a time step, then the microsimulation gives the first representative individual an exposure date for the first agent at that time step.

Then, for every time step in the microsimulation following exposure of the first representative individual to the first agent, the first representative individual experiences the possibility of injury after exposure to the first agent. If, based on the probability of injury after exposure to the first agent, the first representative individual is injured during a time step, then the microsimulation gives the first representative individual an injury date at that time step.

Finally, for every time step in the microsimulation following injury of the first representative individual, the first representative individual experiences the possibility of filing a claim due to the injury. If, based on the probability of filing a claim due to the first injury, the first representative individual files a claim during a time step, then the microsimulation gives the first representative individual a claim date at that time step.

The simulated claim generated in this time step is associated with the first agent and can be associated with one or more dates (e.g., exposure date, injury date, claim date, settlement date, policy date, etc.). For example, the simulated claim may be associated with the exposure date, the injury date, and/or the claim date. In some embodiments, the simulated claim may be associated with a settlement date, the date at which a settlement on the claim is paid to the first representative individual.

In some embodiments, the plurality of simulated claims may be generated based on a projected distribution of future states of science with respect to a first hypothesis that the first agent causes the first injury. For example, the co-occurrence of (1) a future state of science that more strongly supports the first hypothesis (e.g., above a threshold level of scientific acceptance), and (2) a representative individual having acquired the first injury and having been present in the exposure setting, can cause a simulated claim to be generated and the associated loss to be estimated. Further, the plurality of simulated claims may be generated based on a projected distribution of liability risk, which may itself be generated based on the projected distribution of future states of science with respect to the first hypothesis.

In some embodiments, the simulated claim may be associated with a policy date, the policy year to which the claim is assigned for insurance purposes by an insurance company. Insurance companies and/or reinsurers may find it useful to only look at claims assigned to certain policy years, and a latent risk assessment user interface (e.g., the user interfaces illustrated in FIGS. 1A and 1B) may include a date selector to allow a user to limit the visualization to include claims only from certain policy years. Further, some insurance policies use different rules or “triggers” to determine the policy year to which a claim is assigned. For example, a first rule might determine that the policy year of the claim is the exposure date of the claim, whereas a second rule might determine that the policy year is the injury date. A third rule might batch all claims past a target date to the year of the target date. In some embodiments, a latent risk assessment user interface may include a trigger selector to allow a user to choose a particular rule for determining policy year (including, for example, choosing a target date for batching).

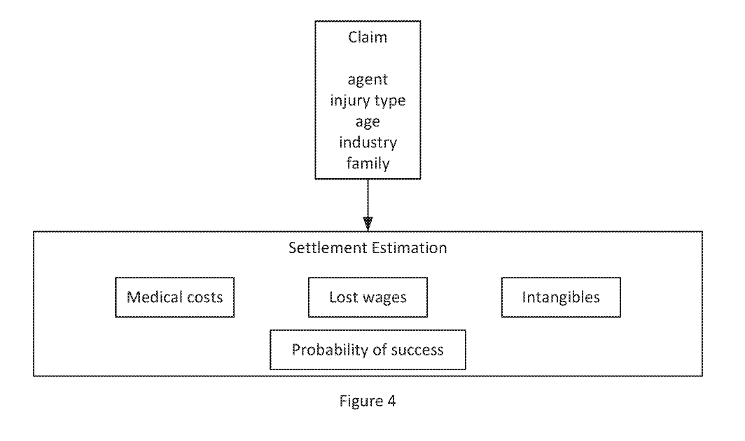

In some embodiments, the microsimulation includes estimating a settlement for each of the simulated claims. FIG. 4 illustrates an exemplary settlement model according to embodiments of the disclosure. A settlement estimation can be based on estimated medical costs, estimated lost wages, intangible damages (e.g., pain and suffering, and loss of consortium), and/or a probability of success.

In some embodiments, medical costs can be estimated based on the type of injury associated with the claim. For example, the claim may be associated with a specific ICD-9 code indicating the type of injury or disease, and a database of administrative or survey data can provide probabilistic estimated medical costs for that injury to automate this estimation. The medical costs computation can be further based on survival probabilities associated with the injury and/or the age of the injured representative individual to estimate lifetime medical costs due to the injury.

In some embodiments, lost wages can be estimated based on the industry in which the simulated representative individual works, and a database of administrative or survey data can provide probabilistic estimated wage information for a job in that industry. The lost wages estimation can be further based on the age of the injured representative individual to estimate the number of remaining working years. In addition, the lost wages estimation can be based on the type of injury—each injury can be associated with a proportion of wages that would be lost. For example, a small proportion of wages are lost for a minor injury, a large proportion of wages are lost of a major injury, and all wages are lost in case of death.

In some embodiments, intangible damages can be based on simulated family information of the injured representative individual. For example, loss of consortium damages depend directly on whether the injured representative individual is married or has children. This family information can also be simulated probabilistically in the microsimulation.

In some embodiments, the settlement estimation can be further based on a probability of success of the claim. As discussed above, a probability of success may include a liability risk score calculated based on a general causation score (e.g., a likelihood that the agent causes the harm, calculated based on scientific literature) and/or a specific causation score (e.g., a likelihood that a particular defendant in a particular setting was responsible for a harm). For example, a first settlement amount for a first claim may be lower than a second settlement amount for a second claim where the probability of success associated with the first claim is lower than the probability of success associated with the second claim, all else being equal. In some embodiments, the probability of success is based on a probability distribution of scores estimated based on the settlement date associated with the claim. This allows the settlement estimation to be further based on an estimated state of science at the time of the settlement.

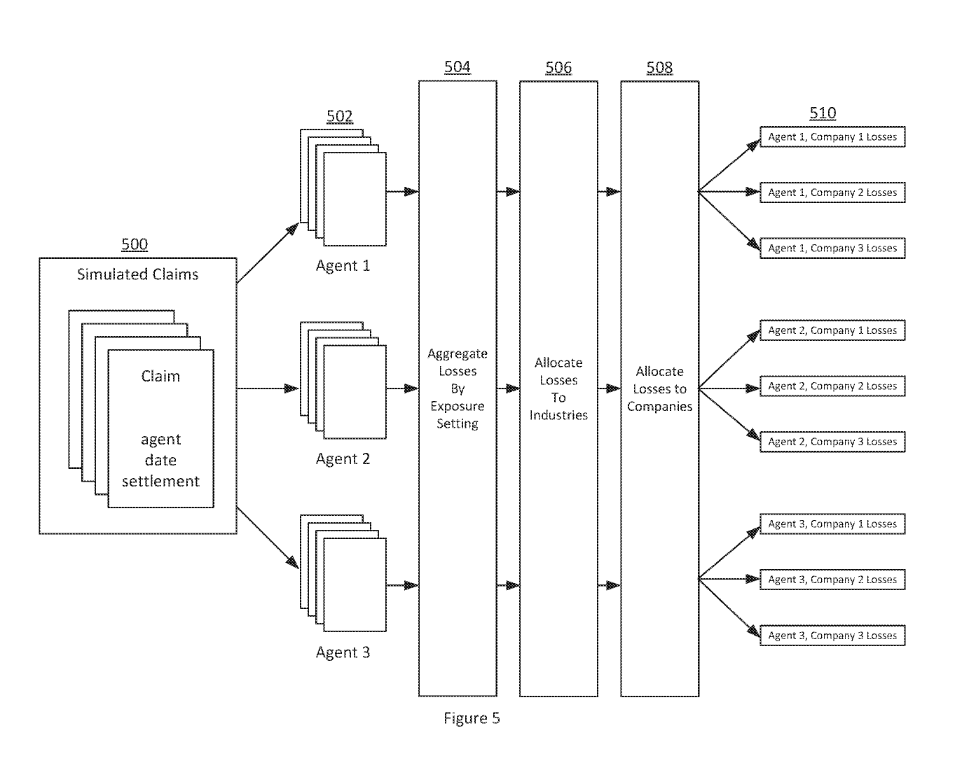

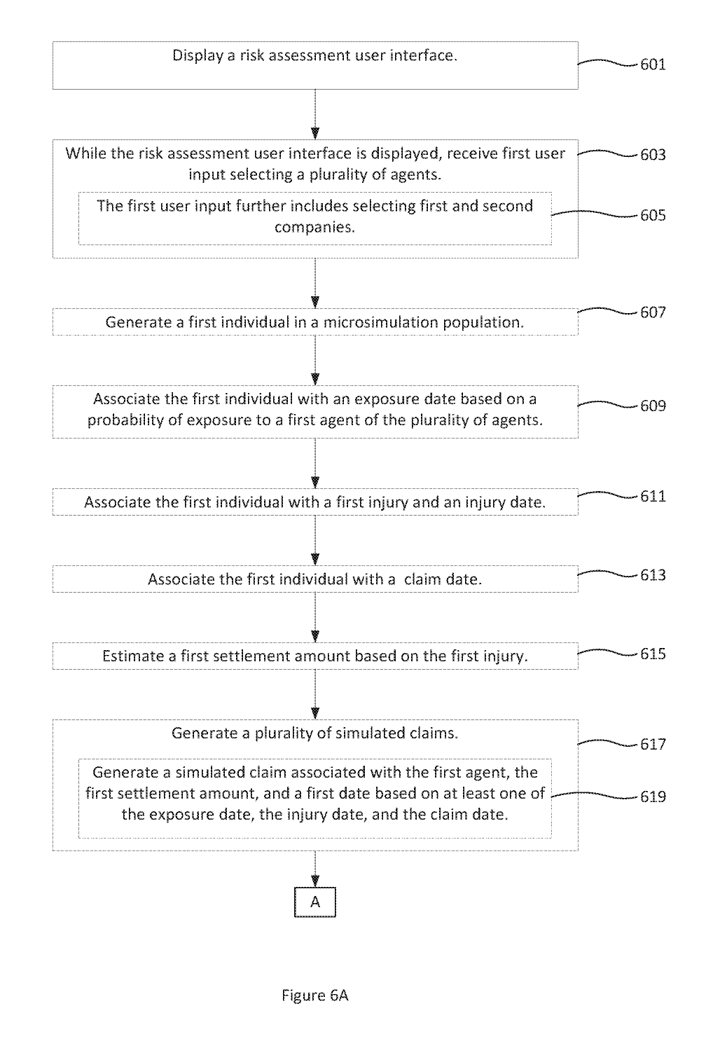

FIG. 5 illustrates an exemplary allocation of losses from simulated claims among a plurality of companies according to embodiments of the disclosure. The simulated claims 500) can be organized into groups based on the agent associated with each claim (502). Then, the losses (e.g., settlement amounts) in each group can be aggregated based on exposure settings (504). For example, the settlement amount associated with all the claims associated with a first exposure setting can be aggregated to obtain aggregated losses due to the first exposure setting, and the settlement amount associated with all the claims associated with a second exposure setting can be aggregated to obtain aggregated losses due to the second exposure setting.

Next, the losses can be allocated to a plurality of industries associated with the exposure settings (506). Each industry can be considered a distinct commercial activity with respect to the claim and the exposure setting. For example, for a claimed injury due to a consumer's exposure to DEHP in PVC flooring, the distinct commercial activities might include DEHP manufacturing, PVC manufacturing, flooring manufacturing and flooring retail. Each of these commercial activities has some probability (e.g., liability risk) of being implicated in a claimed injury after a consumer's exposure to BPA in PVC flooring.

In one example, if there are three industries associated with the first exposure setting, then the aggregated losses due to the first exposure setting can be allocated to a first industry portion associated with the first industry, a second industry portion associated with the second industry, and a third industry portion associated with the third industry. Similarly, if there are three industries associated with the second exposure setting, then the aggregated losses due to the second exposure setting can be allocated to a first industry portion associated with the first industry, a second industry portion associated with the second industry, and a third industry portion associated with the third industry.

In some embodiments, the allocation can be performed based on relative liability risk associated with each exposure setting/industry pair. As discussed above, the liability risk can be based on a probability distribution associated with an estimated future state of science. In one example, for a first exposure setting, a first industry has a.23 liability risk score, a second industry has a.20 liability risk score, and a third industry has a.10 liability risk score. Aggregated losses for the first exposure setting can be allocated proportionally among the three industries so that the first industry is allocated 43% of the losses, the second industry is allocated 38% of the losses, and the third industry is allocated 19% of the losses. In some embodiments, the liability risk can be modeled with a distribution (e.g., using means and standard deviations, or other parametrizations), and the aggregated losses can be allocated among the industries accordingly in a probabilistic manner.

Next, the losses can be allocated to a plurality of companies associated with the industries (508) to obtain portions of the aggregated losses associated with each of the plurality of companies (510). For example, if there are three companies associated with the first industry, then the losses allocated to the first industry can be allocated to a first company portion associated with the first company, a second company portion associated with the second company, and a third company portion associated with the third company. Similarly, if there are three companies associated with the second industry, then the losses allocated to the second industry can be allocated to a first company portion associated with the first company, a second company portion associated with the second company, and a third company portion associated with the third company.

In some embodiments, the allocation to companies can be performed based on market share data for each industry. For example, if the first company has a 40% share of the first industry, the second company has a 35% share of the first industry, and the third company has a 25% share of the first industry, then the aggregated losses allocated to the first industry can be further allocated 40% to the first company, 35% to the second company, and 25% to the third company. In some embodiments, the market share data can be modeled with a distribution (e.g., using means and standard deviations, or other parametrizations), and the aggregated losses can be allocated among the companies accordingly in a probabilistic manner.

In some embodiments, after aggregated losses have been allocated among companies, a company's losses may be aggregated across multiple agents. For example, if a user has selected a first company, a first agent, and a third agent for display in a user interface (e.g., in FIG. 1A or 1B), then the first company's losses due to the first agent can be aggregated with the first company's losses due to the third agent, and the aggregated data may be displayed (e.g., in a loss-time curve, as illustrated in FIG. 1A).

In some embodiments, aggregation can be limited by a date or date range selected via user input on a date selector in the latent risk assessment user interface. As discussed above, a date selector may be used to limit the aggregation only to claims with a policy date that falls within the selected date range. In some embodiments, other dates may be selected by a user, such as the exposure date, the injury date, the date the claim was made, and/or the settlement date. For example, if a user uses a date selector in the latent risk assessment interface to select claims with exposure dates between 2010-2025, then the settlement amounts from any claims having exposure dates outside that range may be excluded from the aggregation and allocation steps in generating the curves in the latent risk assessment user interface.

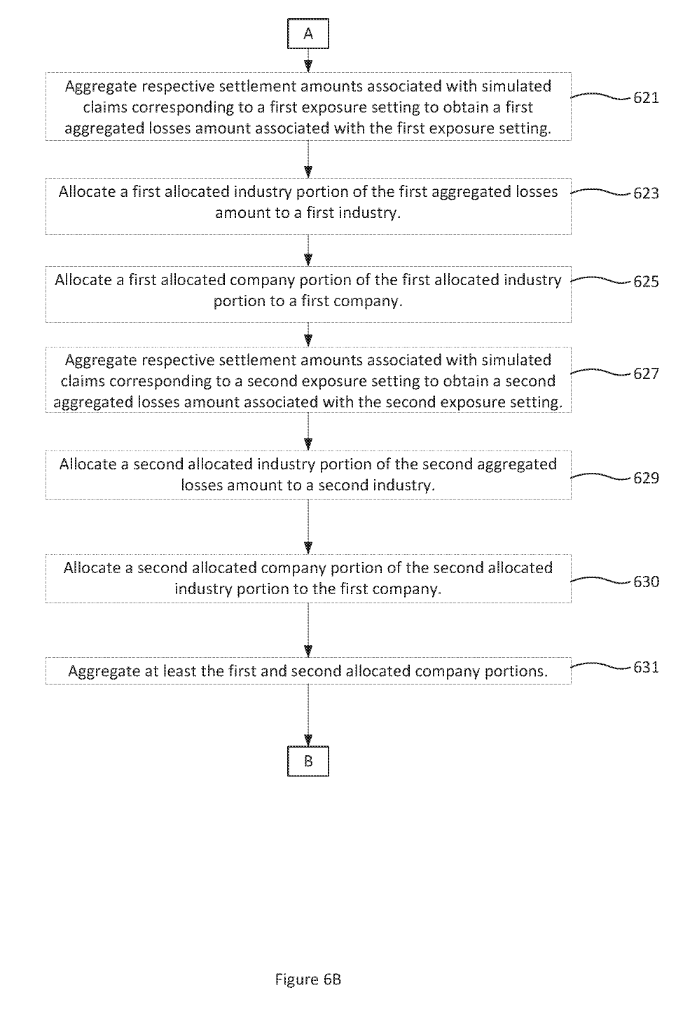

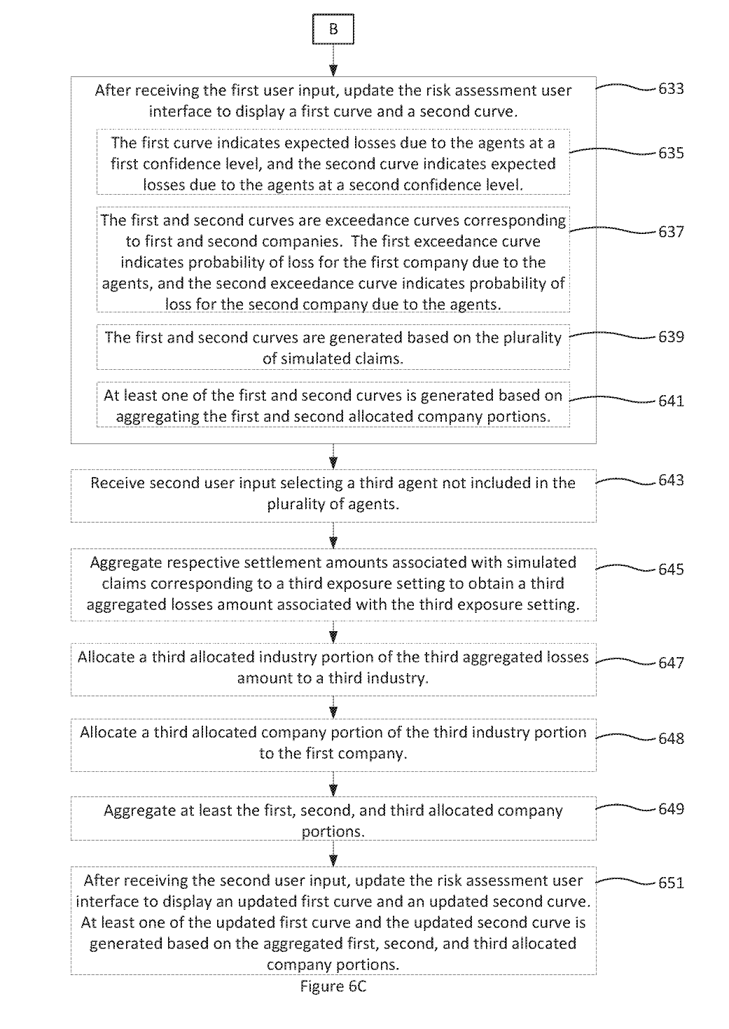

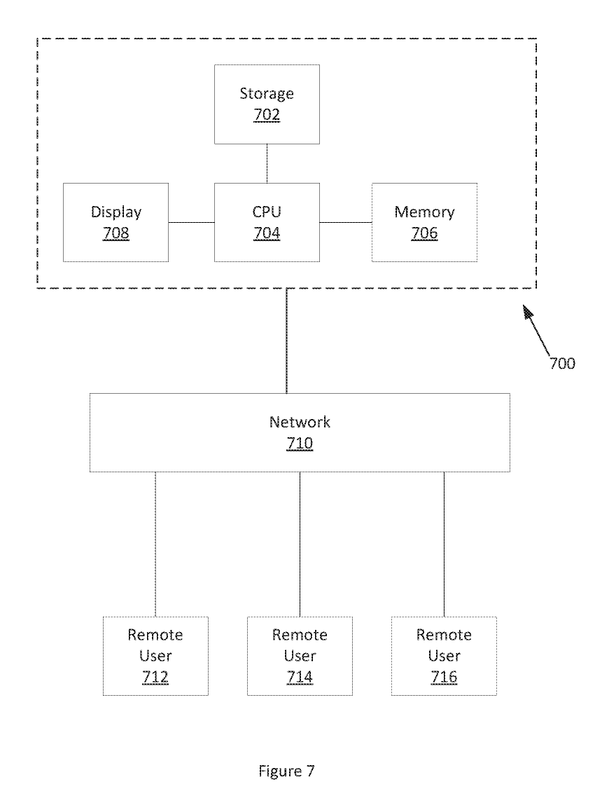

FIGS. 6A-6C illustrate an exemplary method of a latent risk assessment user interface according to embodiments of the disclosure. In some embodiments, a computing device (e.g., device 700 in FIG. 7) includes a display and an input device (e.g., a keyboard, mouse, touchpad, touchscreen, etc.). The computing device 700 displays (601), on the display, a latent risk assessment user interface (e.g., including, in a first region, a time axis and a loss axis, and, in a second region, an agent selector). While the latent risk assessment user interface is displayed, the computing device receives (603), at the input device, first user input selecting (e.g., via the agent selector) a plurality of agents (e.g., a hypothesized cause of an outcome, including a chemical, a material, a process, a business practice, and/or a behavior, among numerous other possibilities).

After receiving the first user input (e.g., in response to the receiving the first user input or in response to receiving a subsequent user input, such as selection of a user interface object for generating/updating the curves), the computing device 700 updates (633) the latent risk assessment user interface to display a first curve and a second curve. In some embodiments, the first curve indicates (635) expected losses due to the plurality of agents over time at a first probability level (e.g., at a 5% or 1% probability level, among other possibilities), and the second curve indicates expected losses due to the plurality of agents over time at a second probability level (different from the first probability level).

In some embodiments, the first and second curves are generated (639) based on a plurality of simulated claims, each respective claim of the plurality of simulated claims being associated with an agent (e.g., an agent that caused an injury that gave rise to the respective claim) of the plurality of agents, a date (e.g., a year in which the respective claim would be paid, or policy year to which the respective claim is assigned), and a settlement amount (e.g., a settlement amount to cover an injury that gave rise to the respective claim).

In some embodiments, the computing device 700 generates (607) a first representative individual in a microsimulation population. The first representative individual is associated (609) with an exposure date based on a probability of exposure to a first agent of the plurality of agents (e.g., for every time step in the microsimulation, the first representative individual experiences the possibility of exposure to the first agent; if, based on the probability of exposure to the first agent, the first representative individual is exposed during a time step, then the exposure date for the first representative individual is set to be the date of that time step). Then, the first representative individual is associated (611) with a first injury and an injury date based on a probability of injury after exposure to the first agent (e.g., for every time step in the microsimulation following exposure of the first representative individual, the exposed first representative individual experiences the possibility of injury after exposure to the first agent; if, based on the probability of injury after exposure to the first agent, the first representative individual is injured during a time step, then the injury date for the first representative individual is set to be the date of that time step). Then, the first representative individual is associated (613) with a claim date based on a probability of claiming due to the first injury (e.g., for every time step in the microsimulation following injury of the first representative individual, the injured first representative individual experiences the possibility of filing a claim due to the injury; if, based on the probability of claiming due to the first injury, the first representative individual files a claim during a time step, then the claim date for the first representative individual is set to be the date of that time step). The computing device 700 estimates (615) a first settlement amount based on the first injury.

In some embodiments, the computing device 700 generates (619) a simulated claim associated with the first agent, the first settlement amount, and a first date based on at least one of the exposure date, the injury date, and the claim date, and the simulated claim is included in the plurality of simulated claims 617).

In some embodiments, the computing device 700 aggregates (621) respective settlement amounts associated with simulated claims corresponding to a first exposure setting associated with a first agent of the selected plurality of agents to obtain a first aggregated losses amount associated with the first exposure setting; allocates (623) a first allocated industry portion of the first aggregated losses amount to a first industry associated with the first exposure setting based on a liability risk associated with the first industry and the first exposure setting; and allocates (625) a first allocated company portion of the first allocated industry portion to a first company in the first industry based on a first market share associated with the first company in the first industry. In some embodiments, the first and second curves are associated with the first company, and at least one of the first and second curves is generated based on the first allocated company portion.

In some embodiments, the computing device 700 aggregates (627) respective settlement amounts associated with simulated claims corresponding to a second exposure setting associated with a second agent of the selected plurality of agents to obtain a second aggregated losses amount associated with the second exposure setting; allocates (629) a second allocated industry portion of the second aggregated losses amount to a second industry associated with the second exposure setting based on a liability risk associated with the second industry and the second exposure setting; allocates (630) a second allocated company portion of the second allocated industry portion to the first company in the second industry based on a second market share associated with the first company in the second industry; and aggregates (631) at least the first allocated company portion and the second allocated company portion, wherein at least one of the first and second curves is generated based on aggregating the first allocated company portion and the second allocated company portion (641).

In some embodiments, the computing device 700 receives (643) second user input, at the input device, selecting a third agent not included in the plurality of agents; aggregates (645) respective settlement amounts associated with simulated claims corresponding to a third exposure setting associated with the third agent to obtain a third aggregated losses amount associated with the third exposure setting; allocates (647) a third allocated industry portion of the third aggregated losses amount to a third industry associated with the third exposure setting based on a liability risk associated with the third industry and the third exposure setting; allocates (648) a third allocated company portion of the third allocated industry portion to the first company in the third industry based on a third market share associated with the first company in the third industry; and aggregates (649) at least the first allocated company portion, the second allocated company portion, and the third allocated company portion. After receiving the second user input, the computing device 700 updates (651) the latent risk assessment user interface to display an updated first curve and an updated second curve, wherein at least one of the updated first curve and the updated second curve is generated based on the aggregated first, second, and third company portions.

In some embodiments, some aggregating and allocating steps may be performed before any user input is received. Further, aggregating allocated portions of losses may be performed after and/or in response to particular user input. For example, aggregating portions corresponding to particular selected companies may occur after and/or in response to user input selecting those particular companies.

In some embodiments, the computing device 700 displays (601), on the display, a latent risk assessment user interface. While the latent risk assessment user interface is displayed, the computing device receives (603), at the input device, first user input selecting a plurality of agents and second user input selecting first and second companies (605). After receiving the first user input (e.g., in response to the receiving the first user input or in response to receiving a subsequent user input, such as selection of a user interface object for generating/updating the curves), the computing device updates (633) the latent risk assessment user interface to display first and second exceedance curves corresponding to the first and second companies, wherein the first exceedance curve indicates probability of loss for the first company due to the agents, and the second exceedance curve indicates probability of loss for the second company due to the agents (637).

FIG. 7 illustrates an exemplary system 700 for a latent risk assessment user interface according to embodiments of the disclosure. The system 700 can include a CPU 704, storage 702, memory 706, and display 708. The CPU 704 can perform the methods illustrated in and described with reference to FIGS. 1-6. Additionally, the storage 702 can store data and instructions for performing the methods illustrated and described with reference to FIGS. 1-6. The storage can be any non-transitory computer readable storage medium, such as a solid-state drive or a hard disk drive, among other possibilities. User interfaces, such as those illustrated in FIGS. 1A-1B, may be displayed on the display 708.

The system 700 can communicate with one or more remote users 712, 714, and 716 over a wired or wireless network 710, such as a local area network, wide-area network, or internet, among other possibilities. The steps of the methods disclosed herein may be performed on a single system 700 or on several systems including the remote users 712, 714, and 716.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A method of a computing device including a display and an input device, the method comprising:
displaying, on the display, a latent risk assessment user interface;
while the latent risk assessment user interface is displayed, receiving, at the input device, first user input selecting a plurality of agents; and
after receiving the first user input, updating the latent risk assessment user interface to display a first curve and a second curve, wherein the first curve indicates expected losses due to the plurality of agents over time at a first probability level, and the second curve indicates expected losses due to the plurality of agents over time at a second probability level.

2. The method of claim 1, wherein the first and second curves are generated based on a plurality of simulated claims, each respective claim of the plurality of simulated claims being associated with an agent of the plurality of agents, a date, and a settlement amount.

3. The method of claim 2, the method further comprising:
generating a first representative individual in a microsimulation population;
associating the first representative individual with an exposure date based on a probability of exposure to a first agent of the plurality of agents;
associating the first representative individual with a first injury and an injury date based on a probability of injury after exposure to the first agent;
associating the first representative individual with a claim date based on a probability of claiming due to the first injury; and
estimating a first settlement amount based on the first injury.

4. The method of claim 3, the method further comprising:
generating a simulated claim associated with the first agent, the first settlement amount, and a first date based on at least one of the exposure date, the injury date, and the claim date;
wherein the simulated claim is included in the plurality of simulated claims.

5. The method of claim 2, wherein the plurality of simulated claims are generated based on a projected distribution of future states of science with respect to a first hypothesis that the first agent causes the first injury.

6. The method of claim 5, wherein the plurality of simulated claims are generated based on a projected distribution of liability risk, generated based on the projected distribution of future states of science with respect to the first hypothesis.

7. The method of claim 2, the method further comprising:
aggregating respective settlement amounts associated with simulated claims corresponding to a first exposure setting associated with a first agent of the selected plurality of agents to obtain a first aggregated losses amount associated with the first exposure setting;
allocating a first allocated industry portion of the first aggregated losses amount to a first industry associated with the first exposure setting based on a liability risk associated with the first industry and the first exposure setting; and
allocating a first allocated company portion of the first allocated industry portion to a first company in the first industry based on a first market share associated with the first company in the first industry;
wherein the first and second curves are associated with the first company, and at least one of the first and second curves is generated based on the first allocated company portion.

8. The method of claim 7, the method further comprising:
aggregating respective settlement amounts associated with simulated claims corresponding to a second exposure setting associated with a second agent of the selected plurality of agents to obtain a second aggregated losses amount associated with the second exposure setting;
allocating a second allocated industry portion of the second aggregated losses amount to a second industry associated with the second exposure setting based on a liability risk associated with the second industry and the second exposure setting; and
allocating a second allocated company portion of the second allocated industry portion to the first company in the second industry based on a second market share associated with the first company in the second industry; and
aggregating at least the first allocated company portion and the second allocated company portion, wherein at least one of the first and second curves is generated based on aggregating the first allocated company portion and the second allocated company portion.

9. The method of claim 8, the method further comprising:
receiving second user input, at the input device, selecting a third agent not included in the plurality of agents;
aggregating respective settlement amounts associated with simulated claims corresponding to a third exposure setting associated with the third agent to obtain a third aggregated losses amount associated with the third exposure setting;
allocating a third allocated industry portion of the third aggregated losses amount to a third industry associated with the third exposure setting based on a liability risk associated with the third industry and the third exposure setting; and
allocating a third allocated company portion of the third allocated industry portion to the first company in the third industry based on a third market share associated with the first company in the third industry;
aggregating at least the first allocated company portion, the second allocated company portion, and the third allocated company portion; and
after receiving the second user input, updating the latent risk assessment user interface to display an updated first curve and an updated second curve, wherein at least one of the updated first curve and the updated second curve is generated based on the aggregated first, second, and third company portions.

10. A method of a computing device including a display and an input device, the method comprising:
displaying, on the display, a latent risk assessment user interface;
while the latent risk assessment user interface is displayed, receiving, at the input device, first user input selecting a plurality of agents and second user input selecting first and second companies; and
after receiving the first user input, updating the latent risk assessment user interface to display first and second exceedance curves corresponding to the first and second companies, wherein the first exceedance curve indicates probability of loss for the first company due to the agents, and the second exceedance curve indicates probability of loss for the second company due to the agents.

11. A non-transitory computer readable medium storing instructions that, when executed by a computing device including a display and an input device, causes the computing device to perform a method comprising:
displaying, on the display, a latent risk assessment user interface;
while the latent risk assessment user interface is displayed, receiving, at the input device, first user input selecting a plurality of agents; and
after receiving the first user input, updating the latent risk assessment user interface to display a first curve and a second curve, wherein the first curve indicates expected losses due to the plurality of agents over time at a first probability level, and the second curve indicates expected losses due to the plurality of agents over time at a second probability level.

12. A non-transitory computer readable medium storing instructions that, when executed by a computing device including a display and an input device, causes the computing device to perform a method comprising:
displaying, on the display, a latent risk assessment user interface;
while the latent risk assessment user interface is displayed, receiving, at the input device, first user input selecting a plurality of agents and second user input selecting first and second companies; and
after receiving the first user input, updating the latent risk assessment user interface to display first and second exceedance curves corresponding to the first and second companies, wherein the first exceedance curve indicates probability of loss for the first company due to the agents, and the second exceedance curve indicates probability of loss for the second company due to the agents.

13. A computing device, comprising:
one or more processors;
a display; and
an input device, wherein the one or more processors are configured to perform a method comprising:
displaying, on the display, a latent risk assessment user interface;
while the latent risk assessment user interface is displayed, receiving, at the input device, first user input selecting a plurality of agents; and
after receiving the first user input, updating the latent risk assessment user interface to display a first curve and a second curve, wherein the first curve indicates expected losses due to the plurality of agents over time at a first probability level, and the second curve indicates expected losses due to the plurality of agents over time at a second probability level.

14. A computing device comprising:
one or more processors;
a display; and
an input device, wherein the one or more processors are configured to perform a method comprising:
displaying, on the display, a latent risk assessment user interface;
while the latent risk assessment user interface is displayed, receiving, at the input device, first user input selecting a plurality of agents and second user input selecting first and second companies; and
after receiving the first user input, updating the latent risk assessment user interface to display first and second exceedance curves corresponding to the first and second companies, wherein the first exceedance curve indicates probability of loss for the first company due to the agents, and the second exceedance curve indicates probability of loss for the second company due to the agents.
